(19) United States
(12) Patent Application Publication
(10) Pub. No.: US 2013/0338324 A1
(43) Pub. Date: Dec. 19, 2013

(54) PROCESS FOR POLYMERIZATION OF A DIENE

(71) Applicants: Christine Beierlein, Bochum (DE); Niko Haberkorn, Recklinghausen (DE); Michael Korell, Bochum (DE); Thomas Gruenfelder, Recklinghausen (DE); Norbert Richter, Marl (DE); Michael Oldenkott, Haltern (DE); Juergen Pospiech, Bochum (DE); Martin Haneke, Muenster (DE); Andreas Berlineanu, Marl (DE); Peter Denkinger, Nottuln (DE); Juergen Hellwig, Schwerte (DE)

(72) Inventors: Christine Beierlein, Bochum (DE); Niko Haberkorn, Recklinghausen (DE); Michael Korell, Bochum (DE); Thomas Gruenfelder, Recklinghausen (DE); Norbert Richter, Marl (DE); Michael Oldenkott, Haltern (DE); Juergen Pospiech, Bochum (DE); Martin Haneke, Muenster (DE); Andreas Berlineanu, Marl (DE); Peter Denkinger, Nottuln (DE); Juergen Hellwig, Schwerte (DE)

(73) Assignee: Evonik Industries AG, Essen (DE)

(21) Appl. No.: 13/903,546

(22) Filed: May 28, 2013

(30) Foreign Application Priority Data
May 29, 2012 (EP) EP12169794

(51) Int. Cl. C08F 2/06

(52) U.S. Cl. CPC C08F 2/06
USPC 526/212; 422/131

(57) ABSTRACT

A process for polymerization of a diene is provided. The process comprises: a) reacting the diene with hydrogen peroxide in a hydrophilic organic solvent in the presence of water to obtain a polymerization reaction mixture; b) contacting the polymerization reaction mixture with water having a temperature of from 20 to 80° C. to form a mixture having an organic phase and an aqueous phase; c) removing unreacted gaseous diene from the water mixture obtained in b); d) separating the aqueous phase comprising the hydrophilic solvent from the organic phase of the water mixture; and e) distilling volatile materials from the separated organic phase from d) to obtain the polymerization product; wherein a temperature of the reaction a) is from 50-150° C., a pressure of the reaction a) is from 0 to 50 bar, the unreacted gaseous diene removed in c) is condensed, distilled and the distillate obtained reacted according to a), and the hydrophilic solvent is recovered from the separated aqueous phase and reused according to a). Also provided is an apparatus for conducting the process of the invention.

### CROSS REFERENCE TO RELATED APPLICATIONS

This application claims priority to European Application No. EP 12169794, filed May 29, 2012, the disclosure of which is incorporated herein by reference in its entirety.

### FIELD OF THE INVENTION

The invention relates to a process for the polymerization of a diene, which comprises the steps: reaction of the diene with hydrogen peroxide in a hydrophilic organic solvent in the presence of water to form a reaction mixture at temperatures of from 50 to 150° C. and pressures of 0-50 bar, contacting of the reaction mixture with water, where the temperature of the water is from 20 to 80° C., preferably from 50 to 65° C., separation of unreacted gaseous diene from the reaction mixture which has been contacted with water in step b), followed by condensation, distillation and reuse of the unreacted gaseous diene, separation of the aqueous phase comprising the hydrophilic solvent from the reaction mixture, followed by reuse of the hydrophilic solvent in step a), and purification of the polymerization product by distillation and also an apparatus suitable for this purpose and the use of this apparatus for the polymerization of a diene, where the diene is preferably 1,3-butadiene or isoprene.

### BACKGROUND OF THE INVENTION

Dienes are a class of industrially highly relevant organic compounds. Important representatives such as 1,3-butadiene, isoprene, cyclopentadiene and the like are interesting and important starting materials for chemical syntheses both on the laboratory scale and a large scale. End products produced from dienes encompass synthetic rubber, acrylonitrile-butadiene-styrene and polyamides.

Dienes can be obtained in large quantities from the cracking of petroleum, where they can be isolated from the gas phase of the steam cracker products. The diene monomer building blocks are polymerized for many applications.

Various processes suitable for polymerization of dienes are conventionally known. Thus, DE 2215748 discloses a process for preparing low molecular weight polymers from conjugated dienes. The underlying reaction system comprises trihydrocarbyl orthophosphate esters or alternatively saturated monocyclic, alicyclic alcohols or ketones.

Improvement in respect of the product yield relative to the amount of diene used is sought in conventional processes for diene polymerization. Particularly in those processes which employ oxygen-containing reagents, there is also a need to reduce the risk of explosion by means of a suitable way of carrying out the reaction and purification of the diene monomer.

In the light of this background, it was an object of the invention to provide a process for the polymerization of dienes giving a particularly high yield of polymerized diene relative to the diene monomer used.

A further object of the invention was to provide a process for the polymerization of dienes which satisfies relatively demanding safety requirements, especially in respect of risk of explosion.

A further object of the invention was to provide a process for the polymerization of dienes having a relatively low net consumption of organic solvents, preferably based on the amount of diene polymer obtained.

A further object of the invention was to provide a process for the polymerization of dienes in which the yield of polymerized diene is increased while the viscosity ideally remains low.

### SUMMARY OF THE INVENTION

These and further objects are achieved by the present invention, the first embodiment of which includes a process for polymerization of a diene, the process comprising:

a) reacting the diene with hydrogen peroxide in a hydrophilic organic solvent in the presence of water to obtain a polymerization reaction mixture;

b) contacting the polymerization reaction mixture with water having a temperature of from 20 to 80° C. to form a mixture having an organic phase and an aqueous phase;

c) removing unreacted gaseous diene from the water mixture obtained in b);

d) separating the aqueous phase comprising the hydrophilic solvent from the organic phase of the water mixture; and

e) distilling volatile materials from the separated organic phase from d) to obtain the polymerization product;

wherein

a temperature of the reaction a) is from 50-150° C.,

a pressure of the reaction a) is from 0 to 50 bar,

the unreacted gaseous diene removed in c) is condensed, distilled and the distillate obtained reacted according to a), and

the hydrophilic solvent is recovered from the separated aqueous phase and reused according to a).

In one variant of the above embodiment, the hydrophilic solvent is an alkanol which is liquid at room temperature, and according to a specific variant the alkanol is at least one of isopropanol and ethanol.

In another embodiment, the present invention includes an apparatus to conduct the process according to claim 1, the apparatus comprising:

a reaction vessel (1);

a flash evaporation unit (2) connected to the reaction vessel (1);

a phase separation unit (3) connected to the flash evaporation unit;

a distillation unit (4) connected to the phase separation unit (3);

a condensation unit (5) connected to the flash evaporation unit (2);

a distillation unit (6) connected to the condensation unit (5) and to the reaction vessel (1); and

a distillation unit (7) connected to the phase separation unit (3) and the reaction vessel (1);

wherein

the connection of the flash evaporation unit (2) to the reaction vessel (1) allows discharge of a reaction mixture from (1) to (2),

the connection of flash evaporation unit (2) to both the condensation unit (5) and the phase separation unit (3) is such that unreacted, gaseous diene of the discharged reaction mixture is transferred to the condensation unit (5), subsequently into the distillation unit (6) and finally back into the reaction vessel (1), while reaction mixture separated from the unreacted, gaseous diene is transferred to the phase separation unit (3),

the flash evaporation unit (2) is capable of containing water into which the reaction mixture from the reaction vessel (1) is discharged,

the phase separation unit (3) enables separation of an aqueous phase comprising a hydrophilic organic solvent and transfer of the aqueous phase firstly into the distillation unit (7) and finally back into the reaction vessel (1),

the distillation (4) receives the reaction mixture separated from the aqueous phase distills the product.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a schematic flow diagram and operation unit arrangement according to one embodiment of the invention.

FIG. 2 shows the relative viscosities of the reaction mixture after 135 minutes for Example 2 and Example 12.

### DETAILED DESCRIPTION OF THE PREFERRED EMBODIMENTS

In a first embodiment the present invention provides a process for polymerization of a diene, the process comprising:

a) reacting the diene with hydrogen peroxide in a hydrophilic organic solvent in the presence of water to obtain a polymerization reaction mixture;

b) contacting the polymerization reaction mixture with water having a temperature of from 20 to 80° C. to form a mixture having an organic phase and an aqueous phase;

c) removing unreacted gaseous diene from the water mixture obtained in b);

d) separating the aqueous phase comprising the hydrophilic solvent from the organic phase of the water mixture; and

e) distilling volatile materials from the separated organic phase from d) to obtain the polymerization product;

wherein

a temperature of the reaction a) is from 50-150° C.,

a pressure of the reaction a) is from 0 to 50 bar,

the unreacted gaseous diene removed in c) is condensed, distilled and the distillate obtained reacted according to a), and

the hydrophilic solvent is recovered from the separated aqueous phase and reused according to a).

Throughout this description all ranges described include all values and sub-ranges therein, unless otherwise specified.

Additionally, the indefinite article “a” or “an” carries the meaning of “one or more” throughout the description, unless otherwise specified.

In a) the reaction of the diene with hydrogen peroxide in a hydrophilic organic solvent in the presence of water to form a reaction mixture may be conducted at temperatures of 50-150° C. and pressures of from 0 to 50 bar. In b) the reaction mixture is contacted with water, wherein the temperature of the water is from 20 to 80° C., preferably from 30 to 70° C., even more preferably from 50 to 65° C. The reaction provides for c) separation of unreacted gaseous diene from the reaction mixture which has been contacted with water in b), followed by condensation, distillation and reuse of the unreacted gaseous diene. Further, the aqueous phase comprising the hydrophilic solvent is separated from the reaction mixture, and the hydrophilic solvent may be reused in a).

In one embodiment, the hydrophilic solvent is an alkanol which is liquid at room temperature, preferably isopropanol or ethanol.

The proportion of the hydrophilic solvent in a) may be from 15 to 30% by weight, preferably from 20 to 30 or from 22 to 30% by weight, that of the diene is from 60 to 80% by weight, that of the water is less than 10% by weight, preferably from 2 to 8.1% by weight and that of the hydrogen peroxide is from 1 to 5% by weight.

The reaction of a) may be carried out at a temperature of from 90 to 130° C., preferably from 110 to 130° C. and the pressure may be from 12 to 30 bar.

In one embodiment, the reaction mixture from a) may have a temperature at the beginning of b) which is not more than 20° C. lower, preferably 15° C. lower, more preferably 10° C. lower, than that in a). In a further preferred embodiment, the reaction mixture from a) may be cooled, preferably by at least 10, 15, 20, 25, 30 or 40° C., before commencement of b).

In an exemplary embodiment, the temperature of the reaction mixture in a) is from 110 to 130° C. and the temperature of the reaction mixture at the beginning of b) is not less than 100° C.

In an embodiment of the present invention, the diene may be 1,3-butadiene or isoprene.

In a further embodiment, the water in b) may have a temperature of at least 40° C., preferably from 40 to 80° C., more preferably from 50 to 65° C.

In a still further embodiment, the condensed diene may be contacted with an antioxidant in c). According to this embodiment, the antioxidant may preferably be selected from the group consisting of dithionite, pyrogallol, ascorbic acid and a mixture comprising bisulphite and sulphite. In a special embodiment, the antioxidant is a mixture comprising bisulphite and sulphite in a final concentration of from 0.1 to 1.5% by weight, preferably from 0.2 to 1% by weight, based on the condensed diene.

In another embodiment, operation d) is carried out using a decanter.

In another embodiment, the reaction mixture from a) is contacted with water without prior cooling in b).

In a variant of the above embodiments, at least part of the unreacted gaseous diene may be separated from the reaction mixture before contacting with water in b), followed by condensation, distillation and reuse of the unreacted gaseous diene.

Another embodiment of the present invention includes an apparatus to conduct the process according to any of the previously described embodiments, wherein the apparatus comprises:

a reaction vessel (1);

a flash evaporation unit (2) connected to the reaction vessel (1);

a phase separation unit (3) connected to the flash evaporation unit;

a distillation unit (4) connected to the phase separation unit (3);

a condensation unit (5) connected to the flash evaporation unit (2);

a distillation unit (6) connected to the condensation unit (5) and to the reaction vessel (1); and

a distillation unit (7) connected to the phase separation unit (3) and the reaction vessel (1);

wherein the connection of the flash evaporation unit (2) to the reaction vessel (1) allows discharge of a reaction mixture from (1) to (2),

the connection of flash evaporation unit (2) to both the condensation unit (5) and the phase separation unit (3) is such that unreacted, gaseous diene of the discharged reaction mixture is transferred to the condensation unit (5), subsequently into the distillation unit (6) and finally back into the reaction vessel (1), while reaction mixture separated from the unreacted, gaseous diene is transferred to the phase separation unit (3),

the flash evaporation unit (2) is capable of containing water into which the reaction mixture from the reaction vessel (1) is discharged,

the phase separation unit (3) enables separation of an aqueous phase comprising a hydrophilic organic solvent and transfer of the aqueous phase firstly into the distillation unit (7) and finally back into the reaction vessel (1),

the distillation (4) receives the reaction mixture separated from the aqueous phase distills the product.

In a variant of the apparatus embodiment the reaction vessel (1) is a vessel made of passivated stainless steel.

In a further variant of the apparatus embodiment, the apparatus is arranged so that reaction mixture or the phase comprising the hydrophilic organic solvent or the unreacted, gaseous diene may be transferred between the reaction vessel (1), the flash apparatus (2), the apparatus for condensation (5), the apparatus for distillation (6), the apparatus for phase separation (3), the apparatus for distillation (7) by suitable connecting pipes.

In a still further embodiment, the condensation unit (5) comprises an antioxidant which is preferably selected from the group consisting of dithionite, pyrogallol, ascorbic acid and a mixture comprising bisulphite and sulphite.

In one apparatus embodiment, the phase separation unit (3) is a decanter.

In a specialized embodiment of the apparatus according to the invention, the reaction vessel (1) is arranged to allow for the transfer of unreacted, gaseous diene from the reaction vessel into condensation unit (5), and subsequently into a distillation unit (6) and finally back into the reaction vessel (1).

The apparatus according to these embodiments may be used for the polymerization of a diene, preferably 1,3-butadiene or isoprene.

The present invention is based on the surprising recognition by the inventors that the yield of a diene polymerization and the purity of the diene polymer product may be increased compared to conventional processes for diene polymerization when the process of the invention is used.

Furthermore, the present invention is based on the surprising recognition by the inventors that the amount of solvent required may be reduced compared to conventional processes for diene polymerization when the process of the invention is used.

Furthermore, the present invention is based on the surprising recognition by the inventors that a process suitable for free-radical polymerization satisfies increased safety requirements when reactive oxygen species which occur are eliminated quickly by contacting the diene with at least one antioxidant after separation from the polymerization reaction.

Furthermore, the present invention is based on the surprising recognition by the inventors that limiting the proportion of water in the reaction mixture in which the polymerization proceeds combined with a high proportion of a hydrophilic organic solvent increases the yield of diene polymerization product.

Dienes may be polymerized in an advantageous way according to the process of the invention. In a preferred embodiment, the term “diene” as used here refers to an organic, aliphatic, branched or unbranched molecule having two double bonds, particularly preferably a molecule of the empirical formula CₙH₂ₙ₋₂. The presence of two double bonds, preferably conjugated double bonds, which allow polymerization after addition of hydrogen peroxide as initiator is critical. Particularly preferred dienes include 1,3-butadiene and isoprene. The polymerization of mixtures of various dienes is also possible according to the invention.

In the process of the invention, the polymerization proceeds in a). The polymerization of the diene after addition of hydrogen peroxide proceeds by a free-radical mechanism in which a hydroxyl radical attacks a C═C double bond of the diene to form a carbon radical and a hydroxyl group on the carbon atom. The carbon radical can propagate the polymerization reaction by attack on a further C═C double bond. The reaction stops, inter alia, as a result of two radicals reacting. Accordingly, the reaction product may be a diene polymer having at least two hydroxy groups. It may also be possible to use specific free-radical scavengers which lead to the formation of diene polymers having other end groups. The molecular weight may, inter alia, be controlled via the concentration and ratio of monomers, initiators and optionally free-radical scavengers.

The polymerization of diene initiated by hydrogen peroxide proceeds, according to the invention, in the presence of a hydrophilic organic solvent and in the presence of water. In a preferred embodiment, the term “hydrophilic organic solvent” refers to an organic solvent which is miscible with water at 25° C. without formation of an organic phase separate from the aqueous phase occurring. In a preferred embodiment, the hydrophilic organic solvent is an unbranched or branched alkanol which is liquid at room temperature, more preferably an unbranched or branched 1-alkanol, most preferably isopropanol or ethanol. The proportion of the hydrophilic organic solvent, preferably ethanol, may be from 15 to 30% by weight, preferably from 17.5 to 30% by weight, more preferably from 20 to 30% or from 22 to 30% by weight. The proportion of water in a), which must not be too high and in order of increasing preference is less than 10, 9, 8, 7, 6, 5 or 4 percent and is particularly preferably from 2 to 8.1% by weight, is critical for achievement of an optimal yield.

The reaction time in a) measured from addition of the initiator may be at least 0.5 hour, more preferably 1, 1.5, 2 or 3 hour(s).

Part of the unreacted diene monomer present at pressures of up to 50 bar may optionally be removed by releasing the pressure immediately after the end of the reaction.

In operation b) of the process of the invention, the reaction mixture from a) is contacted with water. In a preferred embodiment, the water at from 20 to 80° C., preferably from 50 to 65° C., is placed in a suitable vessel, preferably in a flash apparatus, and the reaction mixture from a) is introduced into this vessel.

The water used according to the invention may be, in a particularly preferred embodiment, deionized water.

In c) of the process of the invention, further unreacted gaseous diene may be separated off from the reaction mixture which has been contacted with water in b), preferably in such a way that a reduced pressure relative to atmospheric pressure is applied. In a particularly preferred embodiment, this step may be carried out in a flash apparatus. In a preferred embodiment, the term “flash apparatus” refers to a vessel suitable as depressurization vaporization vessel, for example a stirred vessel which may be made of passivated stainless steel and is heatable and can be placed under vacuum. Operations a) and b)may, in a preferred embodiment, be carried out in the same vessel as long as this is configured as a flash apparatus. The removal of a gas by a flash apparatus is described in Fluidverfahrenstechnik, edited by R. Goedecke, p. 693, 2006 Wiley-VCH Verlag GmbH & Co KGaA, Weinheim.

The unreacted diene which has been separated off, either in a) or in c), may be recovered by condensation and distillation and reused for the polymerization reaction in step a).

The process may be advantageously carried out by contacting the diene condensed in c) with an antioxidant. In a preferred embodiment, the term “antioxidant” as used according to the present invention refers to a compound which lowers the concentration of reactive oxygen compounds. Examples of suitable free-radical scavengers encompass bisulphite, sulphite and dithionite or mixtures thereof. The antioxidant may be, if it is a mixture comprising bisulphite and sulphite, preferably added in a final concentration of from 0.1 to 1.5% by weight, preferably from 0.2 to 1% by weight, to the condensed diene. In a preferred embodiment, the concentration of the antioxidant on contacting with the condensed diene is from 0.1 to 5, more preferably from 0.5 to 5, molecules of antioxidant per molecule of active oxygen compound in the solution comprising the condensed diene, where the term “active oxygen compound” encompasses, in a preferred embodiment, hydrogen peroxide, organic peroxides and oxygen. In a further preferred embodiment, the concentration on contacting with the diene is at least 0.5, 1, 2, 2.5 or 5 molecules of antioxidant per molecule of hydrogen peroxide used in the free-radical polymerization.

In operation d) of the process of the invention, the aqueous phase comprising the hydrophilic organic solvent is separated from the reaction mixture which then comprises predominantly the polymerization product. In a preferred embodiment, the separation may be effected by a decanter which may also be part of the apparatus of the invention. The hydrophilic organic solvent may be recovered from the aqueous phase by distillation and be reused for the polymerization reaction in step a). Distillation processes are described in Fluidverfahrenstechnik, edited by R. Goedecke, p. 689 ff (Chapter 8 Rektifikation) 2006 Wiley-VCH Verlag GmbH & co KGaA, Weinheim.

In a further preferred embodiment, the reaction mixture may be conveyed via a buffer vessel as part of the process of the invention or of the apparatus of the invention before d).

In e) of the process the invention, the polymerization product is freed of organic by-products, for example diene dimers, by distillation, preferably from a thin film evaporator. Suitable processes are described in Fluidverfahrenstechnik, edited by R. Goedecke, p. 637 ff, 2006 Wiley-VCH Verlag GmbH & co KGaA, Weinheim.

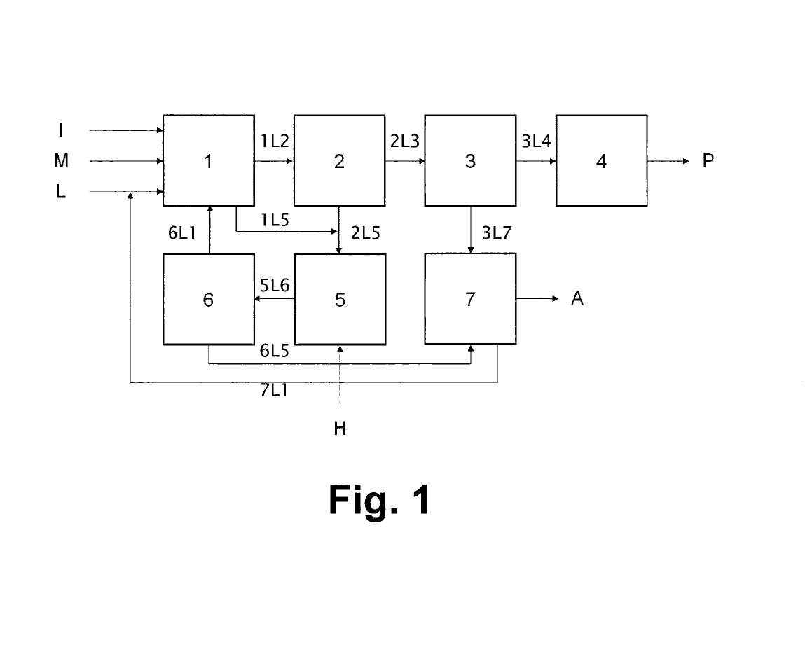

The process of the invention may be suitable for being carried out on any scale, equally well on the laboratory scale or on an industrial scale. In the latter case, the apparatus according to the invention shown in FIG. 1 is particularly suitable. It comprises firstly a reaction vessel (1) for the polymerization of the diene, suitable for reaction of a diene with hydrogen peroxide in a hydrophilic organic solvent to form a reaction mixture. The reaction vessel is preferably a reaction vessel made of passivated stainless steel.

Furthermore, the apparatus of the invention comprises a flash vessel (2) suitable for the reaction mixture being able to be discharged from the reaction vessel (1) into it, suitable for unreacted, gaseous diene being able to be separated from the reaction mixture in the flash evaporation unit (2) and transferred to condensation unit (5), subsequently into a distillation unit (6) and finally back into the reaction vessel (1) and suitable for water to be able to be placed therein and contacted with the reaction mixture from the reaction vessel (1) to form an aqueous phase comprising the hydrophilic organic solvent. The reaction vessel (1) is connected via a line (1L2) to the downstream flash evaporation unit (2).

Furthermore, the apparatus of the invention comprises a phase separation unit (3) which is located downstream of the flash evaporater (2) and is suitable for the reaction mixture separated from the unreacted, gaseous diene in the flash evaporation unit (2) to be able to be transferred into it and is suitable for the aqueous phase comprising the hydrophilic organic solvent to be able to be separated from the reaction mixture and transferred firstly into a distillation unit (7) and finally back into the reaction vessel (1). The phase separation unit (3) is connected via a line (2L3) to the flash evaporation unit (2).

Furthermore, the apparatus of the invention comprises a distillation unit (4) which is located downstream of the phase separation unit (3) and is suitable for the reaction mixture separated off from the aqueous phase comprising the hydrophilic organic solvent in the phase separation unit (3) to be able to be transferred into it and suitable for the product to be able to be freed of the reaction mixture which has been separated off from the aqueous phase comprising the hydrophilic organic solvent by distillation. The phase separation unit (3) is connected via a line (3L4) to the distillation unit (4).

In a preferred embodiment, it is possible for gaseous diene from the reaction vessel to be admitted directly into the apparatus for condensation (5) or via a line (2L5) connecting the flash apparatus (2) to the apparatus for condensation (5), for example via a line (1L5) suitable for this purpose.

In a preferred embodiment, the apparatus for condensation contains at least one antioxidant.

The present invention will be further illustrated by the following figures and nonlimiting examples which indicate further features, embodiments, aspects and advantages of the present invention.

FIG. 1 shows an apparatus according to the invention for carrying out the process of the invention, which comprises a reaction vessel (1) for the polymerization of the diene, a flash evaporation unit (2), an phase separation unit (3) with downstream distillation unit (4), a condensation unit (5), a distillation unit (6) and a further distillation unit (7). The abbreviations represent diene monomer (M), polydiene product (P), initiator hydrogen peroxide (I), solvent (L), wastewater (A) and antioxidant (H). Lines for transferring materials between the vessels are named in the format “XLY”, where X is the number of the vessel from which the material exits and Y is the number of the vessel which the material exiting from the vessel X enters.

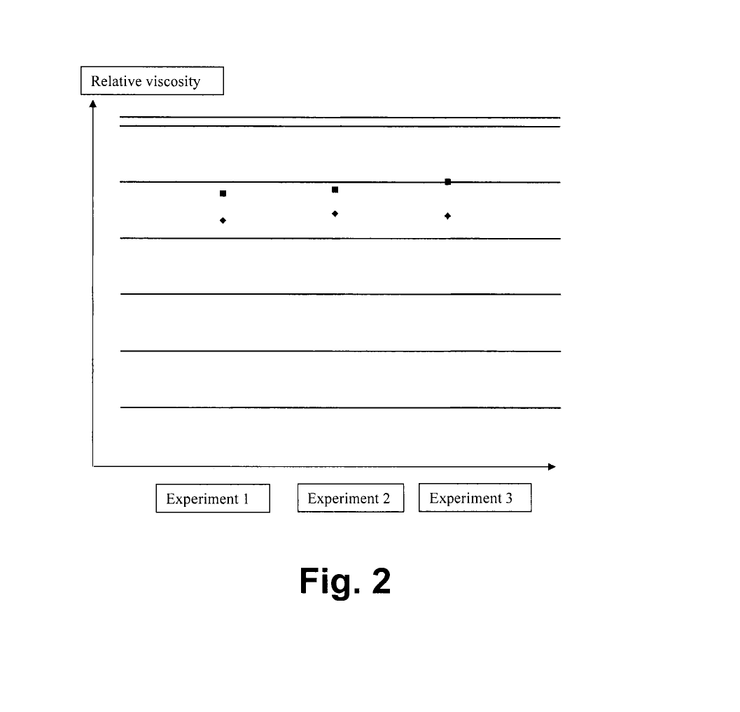

FIG. 2 shows the relative viscosities of the reaction mixture after 135 minutes when the process of the invention is carried out in Example 2 (diamond) and Example 12 (square). The three pairs of points represent three experiments carried out independently of one another. Having generally described this invention, a further understanding can be obtained by reference to certain specific examples which are provided herein for purposes of illustration only, and are not intended to be limiting unless otherwise specified.

### EXAMPLES

### Example 1

491 ml of toluene-denatured ethanol (92% strength) were firstly placed in a passivated 5 l stainless steel autoclave from Büchi (model 4; stainless steel: 1.4571; pressure rating: from −1 to 40 bar). 1214 g of 1,3-butadiene were subsequently introduced. After the temperature had reached at least 90° C., 74 ml of hydrogen peroxide (50% strength) were introduced at at least 14 bar via a lock. The lock was subsequently rinsed with deionized water. The contents of the reactor were then heated further to 120° C. From the point in time at which the hydrogen peroxide was introduced, the reaction mixture was brought to 120° C. for 2 hours and then maintained at this temperature. The pressures during the reaction had a range of 14-28 bar.

After the reaction time had elapsed, the contents of the reactor were cooled to less than or equal to 78° C. After 78° C. had been reached, the contents of the reactor were depressurized into the vessel provided for this purpose (flash apparatus) and the excess butadiene was separated off in the process. This vessel had been charged with 650 g of water at from 40 to 80° C. The contents of the flash vessel were stirred for one hour at 60° C. under a pressure which was from 0.2 to 0.4 below atmospheric pressure in order to remove residual butadiene monomer. After a settling time of from 8 minutes to one hour, two phases were obtained. The upper organic phase contained the desired polymer, while the lower aqueous phase contained the unreacted hydrogen peroxide.

The organic phase was separated from the aqueous phase in a commercial separating funnel. The volatile organic constituents were removed from the organic phase under reduced pressure, leaving 595 g of the desired product, which based on the amount of butadiene used corresponds to a yield of 49%.

### Example 2

491 ml of toluene-denatured ethanol (92% strength) were firstly placed in a passivated 5 l stainless steel autoclave from Büchi (model 4; stainless steel: 1.4571; pressure rating: from −1 to 40 bar). 1214 g of butadiene were subsequently introduced. During the introduction of the butadiene, heating of the contents of the reactor to 90° C.-100° C. was commenced. After at least 90° C. had been reached, 74 ml of hydrogen peroxide (35% strength) were introduced (at at least 14 bar) via a lock. The lock was subsequently rinsed with deionized water. The contents of the reactor were then heated further to 120° C. and maintained at this temperature and pressures of from 14 to 29 bar for the reaction time. The reaction time of 2 hours was measured from the point in time at which the hydrogen peroxide was introduced. After the end of the reaction time, the contents of the reactor were depressurized directly from the polymerization vessel to from 3 bar to 1 bar (pressure flash); this took about 15 minutes. The major part of the 1,3-butadiene was removed from the contents of the reactor and the contents of the reactor were then transferred by means of the residual pressure (from 3 to 1 bar) in the reactor or with application of nitrogen pressure into the flash/washing vessel and the excess butadiene was separated off.

650 g of water at 60° C. had been placed in this flash/washing vessel. The contents of the flash/washing vessel were stirred for one hour at 60° C. under a reduced pressure of from 0.6 to 0.8 bar in order to remove residual butadiene monomer. After a settling time of from 8 minutes to one hour, two phases were obtained. The upper organic phase contained the desired polymer, while the lower aqueous phase contained the unreacted hydrogen peroxide.

The organic phase was separated from the aqueous phase in a commercial separating funnel. The volatile organic constituents were removed from the organic phase under reduced pressure, leaving 575 g of the desired product, which based on the amount of butadiene used corresponds to a yield of 47%.

### Example 3

560 ml of ethanol (92% strength) were firstly placed in a passivated 5 l stainless steel autoclave from Büchi (model 4; stainless steel: 1.4571; pressure rating: from −1 to 40 bar). 1214 g of butadiene were subsequently introduced. After the temperature had reached at least 90° C., 74.0 ml of hydrogen peroxide (50% strength) was introduced (at at least 14 bar) via a lock. The lock was subsequently rinsed with deionized water. The contents of the reactor were then heated further to 120° C. and maintained at this temperature and pressures of from 14 to 29 bar for the reaction time. The reaction time of 2 hours was measured from the point in time at which the hydrogen peroxide was introduced. After the end of the reaction time, the contents of the reactor were depressurized directly from the polymerization vessel to 3 bar (pressure flash); this flash operation took about 15 minutes. The major part of the 1,3-butadiene was removed from the contents of the reactor and the contents of the reactor were then transferred by means of the residual pressure (3 bar) in the reactor and/or alternatively with application of nitrogen pressure into the flash/washing vessel and the excess butadiene was separated off

650 g of water at 60° C. had been placed in this flash/washing vessel. The contents of the flash/washing vessel were stirred for one hour at 60° C. under a reduced pressure of from 0.6 to 0.8 bar absolute in order to remove residual butadiene monomer. After a settling time of from 8 minutes, two phases were obtained. The upper organic phase contained the desired polymer, while the lower aqueous phase contained the unreacted hydrogen peroxide.

The organic phase was separated from the aqueous phase in a commercial separating funnel. The volatile organic constituents were removed from the organic phase under reduced pressure, leaving 633.8 g, which based on the amount of butadiene used corresponds to a yield of 47%.

### Example 4

The procedure was as described in Example 2. As a variation thereof, the reaction time was one hour. A yield of 20% based on the monomer used was obtained. This variation of the mentioned time is associated with a decrease in the viscosity.

### Example 5

The procedure was as described in Example 2. As a variation thereof, the reaction time was 3 hours.

A yield of 55% based on the monomer used was obtained. This variation of the mentioned time is associated with an increase in the viscosity.

### Example 6

The procedure was as described in Example 2. As a variation thereof, the reaction time was 4 hours.

A yield of 62% based on the monomer used was obtained. This variation of the mentioned time is associated with an increase in the viscosity.

### Example 7

The procedure was as described in Example 1, but the amount of hydrogen peroxide was reduced to 80% of the amount specified in Ex. 1. A yield of 43% based on the monomer used was obtained.

### Example 8

The procedure was as described in Example 2, but the amount of hydrogen peroxide was increased to 120% of the amount specified in Ex. 1. A yield of 54.5% based on the monomer used was obtained.

### Example 9

The procedure was as described in Example 1, but isopropanol was used instead of ethanol. A yield of 46% based on the monomer used was obtained.

### Example 10

The procedure was as described in Example 2, but the amount of ethanol was set to 20% by weight of the batch. A yield of 47% based on the monomer used was obtained.

### Example 11

The experiment was carried out as described in Example 2, but the amount of ethanol was set to 30% by weight of the batch. A yield of 43% based on the monomer used was obtained.

### Example 12

The procedure was as in Example 2, but the contents of the reactor were, without prior depressurization of the monomer from the reaction vessel, depressurized into the vessel provided for this purpose (flash unit), resulting in the excess butadiene being separated off The viscosity of the reaction mixture after 135 minutes is plotted in FIG. 2 in comparison with the viscosity as was obtained in the experiment carried out as per Example 2.

It can be seen that early removal of the monomer after the reaction has occurred leads to a reduction in the viscosity.

Numerous modifications and variations on the present invention are possible in light of the above teachings. It is therefore to be understood that within the scope of the appended claims, the invention may be practiced otherwise than as specifically described herein.

1. A process for polymerization of a diene, the process comprising:
a) reacting the diene with hydrogen peroxide in a hydrophilic organic solvent in the presence of water to obtain a polymerization reaction mixture;
b) contacting the polymerization reaction mixture with water having a temperature of from 20 to 80° C. to form a mixture having an organic phase and an aqueous phase;
c) removing unreacted gaseous diene from the water mixture obtained in b);
d) separating the aqueous phase comprising the hydrophilic solvent from the organic phase of the water mixture; and
e) distilling volatile materials from the separated organic phase from d) to obtain the polymerization product;
wherein
a temperature of the reaction a) is from 50-150° C.,
a pressure of the reaction a) is from 0 to 50 bar,
the unreacted gaseous diene removed in c) is condensed, distilled and the distillate obtained reacted according to a), and
the hydrophilic solvent is recovered from the separated aqueous phase and reused according to a).

2. The process according to claim 1, wherein the hydrophilic solvent is an alkanol which is liquid at room temperature.

3. The process according to claim 2, wherein the alkanol is at least one of isopropanol and ethanol.

4. The process according to claim 1, wherein at a start of the reaction of a) the reaction mixture comprises:
15 to 30% by weight of the hydrophilic solvent;
60 to 80% by weight of the diene;
less than 10% by weight water; and
1 to 5% by weight hydrogen peroxide.

5. The process according to claim 1 wherein the temperature of the reaction a) is from 90 to 130° C.

6. The process according to claim 1 wherein the pressure of the reaction a) is from 12 to 30 bar.

7. The process according to claim 1 wherein a temperature of the reaction mixture a) at a start of the contacting with water in b) is not more than 20° C. lower than the temperature of the reaction in a).

8. The process according to claim 7, wherein the temperature of the reaction mixture in step a) is from 110 to 130° C. and the temperature of the reaction mixture at the beginning of b) is not less than 100° C.

9. The process according to claim 1, wherein the temperature of the water in b) is from 40 to 80° C.

10. The process according to claim 1, wherein the condensed unreacted diene removed from c) is contacted with an antioxidant and the antioxidant is selected from the group consisting of dithionite, pyrogallol, ascorbic acid and a mixture of bisulphite and sulphite.

11. The process according to claim 10, wherein the antioxidant is a mixture of bisulphite and sulphite and a content of the antioxidant mixture is from 0.1 to 1.5% by weight of the condensed diene.

12. The process according to claim 1, wherein the reaction mixture from a) is contacted with water in b) without prior cooling.

13. The process according to claim 1, further comprising, after the reaction in a), removing at least a portion of unreacted gaseous diene from the polymerization reaction mixture the contacting with water according to b);
wherein the removed portion of unreacted gaseous diene is condensed, distilled and the distillate obtained reacted according to a).

14. An apparatus to conduct the process according to claim 1, the apparatus comprising:
a reaction vessel (1);
a flash evaporation unit (2) connected to the reaction vessel (1);
a phase separation unit (3) connected to the flash evaporation unit;
a distillation unit (4) connected to the phase separation unit (3);
a condensation unit (5) connected to the flash evaporation unit (2);
a distillation unit (6) connected to the condensation unit (5) and to the reaction vessel (1); and
a distillation unit (7) connected to the phase separation unit (3) and the reaction vessel (1);
wherein
the connection of the flash evaporation unit (2) to the reaction vessel (1) allows discharge of a reaction mixture from (1) to (2),
the connection of flash evaporation unit (2) to both the condensation unit (5) and the phase separation unit (3) is such that unreacted, gaseous diene of the discharged reaction mixture is transferred to the condensation unit (5), subsequently into the distillation unit (6) and finally back into the reaction vessel (1), while reaction mixture separated from the unreacted, gaseous diene is transferred to the phase separation unit (3),
the flash evaporation unit (2) is capable of containing water into which the reaction mixture from the reaction vessel (1) is discharged,
the phase separation unit (3) enables separation of an aqueous phase comprising a hydrophilic organic solvent and transfer of the aqueous phase firstly into the distillation unit (7) and finally back into the reaction vessel (1),
the distillation (4) receives the reaction mixture separated from the aqueous phase distills the product.

15. The apparatus according to claim 14, wherein the reaction vessel (1) is a vessel made of passivated stainless steel.

16. The apparatus according to claim 14, further comprising connections such that a reaction mixture or a phase comprising hydrophilic organic solvent or unreacted, gaseous diene can be transferred between the reaction vessel (1), the flash evaporation unit (2), the condensation unit (5), the distillation unit (6), the phase separation unit (3), and the distillation unit (7).

17. The apparatus according to claim 14, wherein the condensation unit (5) comprises an antioxidant, wherein the oxidant is selected from the group consisting of dithionite, pyrogallol, ascorbic acid and a mixture comprising bisulphite and sulphite.

18. The apparatus according to claim 14, further comprising a direct connection of the reaction vessel (1) to the condensation unit (5), wherein unreacted, gaseous diene is transferred from the reaction vessel into the condensation unit (5), subsequently into the distillation unit (6) and finally back into the reaction vessel (1).

19. The process according to claim 1 wherein the diene comprises at least one of 1,4-butadiene and isoprene.

20. The process according to claim 1 wherein the diene consists of 1,4-butadiene or isoprene.
